(19) United States
(12) Patent Application Publication
(10) Pub. No.: US 2026/0356352 A1
(43) Pub. Date: Nov. 12, 2026

(54) METHOD AND PARKING-ASSISTANCE DEVICE FOR DYNAMICALLY PLANNING A PARKING TRAJECTORY OF A VEHICLE DURING AN AT LEAST PARTLY AUTOMATICALLY PERFORMED PARKING PROCESS

(71) Applicant: Continental Autonomous Mobility Germany GmbH, Ingolstadt (DE)

(72) Inventors: Tobias Kranz, Karlstein am Main (DE); Jonas Schönichen, Spiesheim, 55288 (DE); Felix Willmann, Riedstadt (DE)

(73) Assignee: Continental Autonomous Mobility Germany GmbH, Ingolstadt (DE)

(21) Appl. No.: 19/100,315

(22) PCT Filed: Jul. 25, 2023
(86) PCT No.: PCT/DE2023/200154

§ 371 Date: Jan. 31, 2025

(30) Foreign Application Priority Data
Aug. 2, 2022 (DE) 10 2022 207 957.4

(51) Int. Cl. B60W 30/06

(52) U.S. Cl. CPC B60W 30/06

(57) ABSTRACT

A method for dynamically planning a parking trajectory of a vehicle during an at least partly automatically performed parking process, includes detecting an environment of the vehicle with at least one sensor apparatus. A target position is determined for the vehicle based on the environmental data. The method also includes planning a parking trajectory based on the fixed target position, recalculating the target position during the parking process based on environmental data updated during the parking process, and comparing the difference between the fixed target position and a formed average value from at least one subset of the target positions recalculated during the parking process. The fixed target position is updated if the difference between the fixed target position and the formed average value exceeds a specified limit value, dynamically replanning the parking trajectory based on the updated target position.

### CROSS-REFERENCE TO RELATED APPLICATIONS

This application is a national stage application, filed under 35 U.S.C. § 371, of International patent application No. PCT/DE2023/200154, filed on Jul. 25, 2023, which claimed priority to German patent application No. 10 2022 207 957.4, filed on Feb. 8, 2022, each of which is incorporated by reference.

### TECHNICAL FIELD

The technical field relates generally to a method for dynamically planning a parking trajectory of a vehicle during an at least partly automatically performed parking process, to a parking assistance device, and to a vehicle.

### BACKGROUND

Parking assistance systems which can calculate a trajectory based on the current driving scenario, depicted by an environmental model, on which trajectory the vehicle moves in an at least partly automated manner, i.e., for example without a steering intervention by the driver and/or without actuation of the accelerator or brake pedal by the driver, are already known from the prior art.

During the at least partly automated conducting of the parking process, changes can occur to the surroundings model which is provided by a driver assistance system of the vehicle. The alteration of the surroundings model can have different causes, for example, that the surroundings detection is more accurate due to the lower speed during the parking process (compared to the detection when driving past the parking space), that new surroundings details are detected on driving into the parking space, which were not recognized by the sensor technology of the vehicle when driving past the parking space, a change in the parking situation (e.g., parking space is larger or smaller than during the original planning of the parking process) and/or that a temporal change is produced in the surroundings situation, for example as a result of a pedestrian setting foot on the edge of the parking space, etc.

As a result, it can happen that the initially established parking trajectory can no longer be conducted without a collision, or that the vehicle takes up an unfavorable or inaccurately aligned target end position.

In such situations, known parking assistance systems terminated the parking process or at least stop the vehicle. Alternatively, updating the calculated target position based on the new surroundings details is conceivable in order to arrive at a more optimal position for driving into or pulling out of a parking space. However, the consequence of this can be constantly updating the target position, e.g., in every measuring cycle of a sensor unit. Changing the target position is associated with a recalculation of an alternative parking trajectory, which frequently makes maneuvering necessary, i.e., the vehicle is not moved on a parking trajectory which involves a single move, but rather on a parking trajectory which involves multiple moves. This type of replanning is perceived by the vehicle occupants to not be very convenient.

As such, it is desireable to provide a method for dynamically planning a parking trajectory of a vehicle during an at least partly automatically performed parking process which can react to a changed parking situation and has a high parking convenience and, therefore, a high user acceptance.

### SUMMARY

According to a first aspect, the disclosure relates to a method for dynamically planning a parking trajectory of a vehicle during an at least partly automatically performed parking process, in particular the process of driving into or pulling out of a parking space. The vehicle can be, for example, a passenger car with four wheels. A configuration of the vehicle as another type of motor vehicle or as a non-motorized vehicle, for example as a trailer, is possible. In particular, the vehicle can also be a combination of a motor vehicle and a trailer. The method comprises the following steps:

Initially, a vehicle environment, thus purely by way of example a parking spot, a parking space or an inductive charge plate, is detected by at least one sensor apparatus of the vehicle. Based on the environmental data detected by the at least one sensor apparatus, a target position for the vehicle is determined and fixed. Subsequently, the parking trajectory is planned and in particular controlled based on the fixed target position. In particular, the parking trajectory describes a movement of the vehicle to the target position. The environmental data comprise, for example, information from a road model, object information in the vehicle environment and a driving dynamics model of the vehicle.

During the at least partly automatically performed parking process along the planned, initially or last fixed parking trajectory, the target position is recalculated based on environmental data updated during the parking process. The recalculation of the target position serves to establish whether the vehicle is to be moved to a new target position which differs from the first target position. The recalculation is particularly preferably carried out continually, that is to say at regular time intervals.

Following the recalculations of the target position, a comparison is carried out of the difference between the initially or last fixed target position and a formed average value from at least one subset of the target positions recalculated during the parking process. Outliers are preferably not taken into account when forming the average value from the recalculated target positions.

The initially or last fixed target position is updated if the difference between the initially or last fixed target position and the formed average value exceeds a specified limit value. In other words, the parking situation and/or the location of the recalculated target positions is assessed relative to the initially or last fixed target position and adjusted as a function of the assessment result. The parking trajectory is dynamically replanned based on the updated target position.

During the recalculation of the target positions it is possible that the automated parking process has not yet begun, that is to say, for example that an updated environment has already been detected at the start of the parking procedure. However, it can equally be the case that the target positions are recalculated when a part of the current parking trajectory has already been driven through.

Thanks to the method according to the disclosure it can advantageously be ascertained whether a new target position manifests itself via the quantity of the target positions recalculated during the parking process or whether new target positions arise solely due to measurement tolerances. At the same time, larger deviations can be reliably determined by way of averaging the recalculated target positions and are responded to in a timely manner. By contrast, in the event of minor changes in the environment, the target position and parking trajectory are maintained, so that a robust automated parking behavior is ensured. In this way, it is possible to prevent a constant replanning of the parking trajectory, which requires a high level of computational complexity.

According to an exemplary embodiment, the target positions recalculated during the parking process are weighted by the up-to-date nature thereof when forming the average value. In particular, the more recent data is given a higher weighting in order to make it possible to adjust the target position to the current environment.

If it should be necessary to update the fixed target position, the last recalculated target position may be selected as the updated target position. This is advantageous, for example, if there is a slight deviation from the previous target positions and it can be assumed that the last calculated target position indicates a precise value. However, it can equally be provided that the formed average value is selected as the updating target position.

The average value may be formed from at least three recalculated target positions which, however, do not necessarily have to be evaluated consecutively. Rather, the average value of at least three recalculated target positions may take into account a parking space which is detected as completely as possible, thus, for example, the entire lateral boundary of the parking space, is used. In this way, the requirement to update the target position again due to an insufficiently or incompletely detected environment can be reduced.

The fixed target position may include a position and an orientation of the vehicle based on a spatially fixed coordinate system, wherein the update of the target position can relate to the position and/or the orientation. Thus, the check whether the fixed target position is to be updated may include, for example, determining the difference between a specified lateral target position value and the recalculated lateral target position values.

According to one exemplary embodiment, the target position is recalculated in each measuring cycle of the at least one sensor apparatus during the parking process.

According to one exemplary embodiment, the parking process is a diagonal parking process or a perpendicular parking process. These parking processes are characterized by the fact that, due to the large parking spot depth, the initial detection of the parking situation when driving past the parking space is often inadequate, and on at least partly driving into the parking space, the surroundings model is updated, which makes it necessary to replan the first parking trajectory.

According to one exemplary embodiment, the speed of the vehicle when driving through a fixed parking trajectory is between 0.2 m/s and 3 m/s. Thanks to the low speed of the vehicle, the updated parking trajectory can have relatively small curve radii, so that the new target position can be reached even with a relatively short new parking trajectory.

According to a further aspect, the disclosure relates to a parking assistance device for dynamically planning a parking trajectory of a vehicle during an at least partly automatically performed parking process. In particular, the disclosure is advantageous for the automation level SAE Level 2 and higher.

The parking assistance device includes a sensor apparatus for detecting an environment of the vehicle, as well as an evaluation unit which is configured to determine and fix a target position for the vehicle based on the environmental data detected and transmitted by the at least one sensor apparatus. Furthermore, the evaluation unit is configured to plan a parking trajectory based on the fixed target position. The parking trajectory is in particular a combination of circular arc segments, straight lines and/or clothoids, by means of which the fixed target position is reached.

The evaluation unit is configured to recalculate target positions during the parking process based on the environmental data updated during the parking process. Furthermore, the evaluation unit is configured to perform a comparison of the difference between the fixed target position and a formed average value from at least one subset of the target poses recalculated during the parking process and to output an update of the fixed target position if the difference between the fixed target position and the formed average value exceeds a specified limit value. The evaluation unit is configured to carry out a dynamic replanning of the parking trajectory based on the updated target position. In particular, a computing unit is configured to control the vehicle to be parked along the replanned parking trajectory in an automated manner.

According to a further aspect, the disclosure relates to a motor vehicle having a parking assistance device in accordance with the preceding description.

Within the meaning of the disclosure, the expressions “approximately”, “substantially” or “roughly” mean deviations from the exact value in each case by +/−10%, preferably by +/−5%, and/or deviations in the form of alterations which are insignificant to the function.

Further developments, advantages and possible applications of the disclosure are also set out by the following description of exemplary embodiments and by the figures. All of the features described and/or pictured per se or in any combination are in principle the subject-matter of the disclosure, irrespective of their combination in the claims or references back thereto. The content of the claims is also made an integral part of the description.

### BRIEF DESCRIPTION OF THE DRAWINGS

The disclosure is explained in greater detail below on the basis of figures with reference to exemplary embodiments, wherein:

FIG. 1 shows, by way of example, a schematic representation of a parking situation with an initially fixed target position;

FIG. 2 shows, by way of example, the parking situation with an updated target position, based on which the new target position is reached instead of the last fixed target position of the vehicle;

FIG. 3 shows an exemplary series of measurements of recalculated lateral target position values; and

FIG. 4 shows, by way of example, a block diagram which illustrates the method steps of the method for dynamically replanning the fixed parking trajectory.

### DETAILED DESCRIPTION

The present disclosure relates to a method for dynamically planning a parking trajectory of a vehicle during an at least partly automatically performed parking process by a parking assistance device. “Dynamic planning” means that following the determination of a new target position, which takes the changed surroundings situation of the vehicle into account, the vehicle is moved further along a parking trajectory which is adapted to the new target position. The trigger for replanning the parking trajectory can be generated automatically by an evaluation unit of the vehicle, for example when it is recognized by a sensor apparatus of the vehicle that the parking situation has changed and a new target position has to be taken up by the vehicle. Such a change in the parking situation exists, for example, if the parking space which is to be parked in by means of the parking process has increased or decreased in size, an initially unrecognized object is restricting the parking space or the parking space alignment was initially assumed to be different.

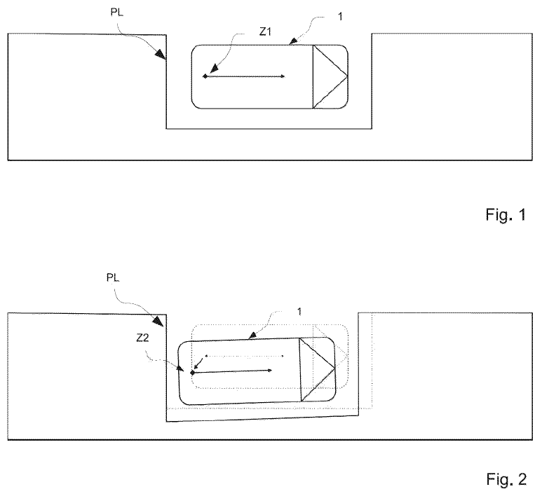

FIG. 1 shows, by way of example and schematically, an initially fixed target position Z1 for a parking process of a vehicle 1 which is to be driven into a parking space PL. The parking space PL is restricted, for example, by objects such as third-party vehicles, curbs or boundary lines.

For example, due to the speed of the vehicle 1 when driving past the parking space PL and/or the distance of the vehicle 1 from the parking space PL, it can happen that the parking trajectory is planned based on a surroundings model which does not correspond to the parking situation actually prevailing. Thus, for example, it is only on driving into the parking space that an obstacle can be recognized, which is a hindrance to a positioning of the vehicle 1 in the initially fixed target position Z1, so that a replanning of the initially fixed target position Z1 to a new target position Z2 and, as a consequence, a new parking trajectory becomes necessary.

The first target position Z1 is in particular generated based on a surroundings model which was created prior to the start of the parking process. After the parking process has been started and, in particular, the vehicle 1 is moved on the initial parking trajectory by the parking assistance device, the target position is recalculated at regular intervals based on environmental data updated during the parking process.

FIG. 2 shows an updated target position Z2 which differs from the initial target position Z1 and to which the vehicle 1 is to be maneuvered along a newly planned parking trajectory.

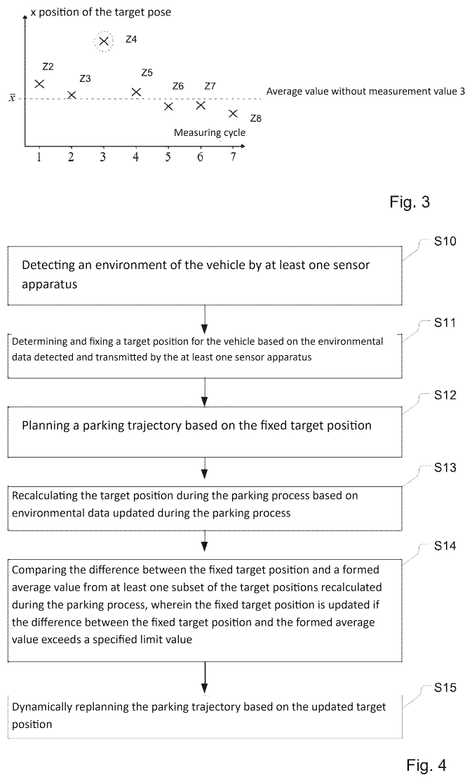

FIG. 3 shows, purely by way of example, seven recalculated lateral target positions Z2-Z8. An average value is formed from at least one subset of these recalculated target positions Z2-Z8. In the case of this exemplary embodiment, the measured value 3 appears to be an outlier and, as a consequence, is not taken into account when forming the average value. The target positions Z2-Z8 are recalculated, for example, in each measuring cycle of the at least one sensor apparatus of the vehicle 1.

In order to ascertain with little computational effort whether updating of the planned parking trajectory is required, the difference between the fixed target position Z1 and a formed average value from at least one subset of the recalculated target positions Z2-Z8 is compared. If the difference between the fixed target position Z1 and the formed average value exceeds a specified limit value, the fixed target position Z1 is updated. In this way, a dynamic and robust correction of target positions is attained and, as a consequence, disadvantageous parking positions are avoided.

FIG. 4 shows a schematic block diagram which illustrates the method for dynamically planning the parking trajectory of the vehicle 1 during an at least partly automatically performed parking process. Initially, an environment of the vehicle 1 is detected by at least one sensor apparatus S10. In a next step, the target position Z1 for the vehicle 1 is determined and fixed based on the environmental data detected by the at least one sensor apparatus S11, wherein the parking trajectory is planned based on the fixed target position S12. The target position is recalculated during the parking process based on environmental data updated during the parking process S13. In a next step, the difference between the fixed target position and a formed average value from at least one subset of the target positions Z2-Zx recalculated during the parking process is compared, wherein the fixed target position is updated if the difference between the fixed target position and the formed average value exceeds a specified limit value S14. The parking trajectory is dynamically replanned based on the updated target position S15.

The previously described method is suitable for parallel, perpendicular or diagonal parking situations.

1-10. (canceled)

11. A method for dynamically planning a parking trajectory of a vehicle during an at least partly automatically performed parking process, wherein the method comprises:
detecting an environment of the vehicle using at least one sensor apparatus;
determining and fixing a target position for the vehicle based on the environmental data detected by the at least one sensor apparatus;
planning a parking trajectory based on the fixed target position;
recalculating the target position during the parking process based on environmental data updated during the parking process;
comparing the difference between the fixed target position and a formed average value from at least one subset of the recalculated target positions recalculated during the parking process, wherein the fixed target position is updated if the difference between the fixed target position and the formed average value exceeds a specified limit value; and
dynamically replanning the parking trajectory based on the updated target position.

12. The method according to claim 11, wherein the target positions recalculated during the parking process are weighted by the up-to-date nature thereof when forming the average value.

13. The method according to claim 11, wherein the fixed target position comprises a position and an orientation of the vehicle based on a spatially fixed coordinate system, wherein the update of the target position can relate to the position and/or the orientation.

14. The method according to claim 11, wherein the average value is formed from at least three recalculated target positions which take into account a parking space which is detected as completely as possible.

15. The method according to claim 11, wherein the last recalculated target position is selected as the updating target position.

16. The method according to claim 11, wherein the target position is recalculated in each measuring cycle of the at least one sensor apparatus during the parking process.

17. The method according to claim 11, wherein the parking process is a diagonal parking process or a perpendicular parking process.

18. The method according to claim 11, wherein the speed of the vehicle when driving through a fixed parking trajectory is between 0.2 m/s and 3 m/s.

19. A parking assistance device for dynamically planning a parking trajectory of a vehicle during an at least partly automatically performed parking process, comprising:
a sensor apparatus for detecting an environment of the vehicle;
an evaluation unit which is configured to determine and fix a target position for the vehicle based on the environmental data detected and transmitted by the at least one sensor apparatus;
wherein the evaluation unit is configured to plan a parking trajectory based on the fixed target position;
wherein the evaluation unit is configured to recalculate target positions during the parking process based on the environmental data updated during the parking process;
wherein the evaluation unit is configured to conduct a comparison of the difference between the fixed target position and a formed average value from at least one subset of the target positions recalculated during the parking process and to output an update of the fixed target position if the difference between the fixed target position and the formed average value exceeds a specified limit value;
wherein the evaluation unit is configured to carry out a dynamic replanning of the parking trajectory based on the updated target position.

20. A motor vehicle comprising:
a parking assistance device for dynamically planning a parking trajectory of a vehicle during an at least partly automatically performed parking process, the parking assistance device including
a sensor apparatus for detecting an environment of the vehicle,
an evaluation unit which is configured to determine and fix a target position for the vehicle based on the environmental data detected and transmitted by the at least one sensor apparatus,
wherein the evaluation unit is configured to plan a parking trajectory based on the fixed target position,
wherein the evaluation unit is configured to recalculate target positions during the parking process based on the environmental data updated during the parking process,
wherein the evaluation unit is configured to conduct a comparison of the difference between the fixed target position and a formed average value from at least one subset of the target positions recalculated during the parking process and to output an update of the fixed target position if the difference between the fixed target position and the formed average value exceeds a specified limit value,
wherein the evaluation unit is configured to carry out a dynamic replanning of the parking trajectory based on the updated target position.
